(19) United States
(12) Patent Application Publication
(10) Pub. No.: US 2015/0168765 A1
(43) Pub. Date: Jun. 18, 2015

(54) LCD DEVICE

(71) Applicant: Shenzhen China Star Optoelectronics Technology Co., Ltd., Shenzhen (CN)

(72) Inventor: Gang Yu, Shenzhen (CN)

(21) Appl. No.: 13/636,703

(22) PCT Filed: Aug. 31, 2012
(86) PCT No.: PCT/CN2012/080850

§ 371 Date: Sep. 24, 2012

(30) Foreign Application Priority Data
Aug. 21, 2012 (CN) 201210299153.1

(51) Int. Cl. G02F 1/1333; G02F 1/1335

(52) U.S. Cl. CPC G02F 1/133308; G02F 1/133528; G02F 2001/133317

(57) ABSTRACT

The present invention proposes an LCD device. The LCD device includes: an LCD panel; a frame, comprising a fixing groove, for carrying on the LCD panel; an optical film on the LCD panel; and a fixing film comprising a plurality of fixing holes and an opening, the optical film engaged with the opening to prevent the optical film from moving. A plurality of fixing components go through the fixing holes and the fixing grooves one by one to attach the fixing film onto the frame. The optical film does not become deformed under pull to deteriorate because the optical film has no need to arrange fixing holes for attaching the optical film onto a frame by screwing.

### BACKGROUND OF THE INVENTION

1. Field of the Invention

The present invention relates to a liquid crystal display (LCD) technology, more particularly, to an LCD device for fixing an optical film.

2. Description of the Prior Art

LCDs are widely used in modem information equipments such as computers, cell phones, personal digital assistances (PDAs), etc, due to their thin, lightweight, low power consumption features. Generally, an LCD comprises a liquid crystal panel and a backlight module. Since the liquid crystal panel itself does not light, the LCD requires light sources which emit light from the backlight module. Light emitted by the backlight modules passes through liquid crystals in the liquid crystal panel. The intensity of light which would be conveyed to a viewer is adjusted by means of an alignment of the liquid crystals. Subsequently, images are produced.

Please referring to FIG. 1, FIG. 1 illustrates a structure of a conventional LCD device 10. The LCD device 10 comprises an LCD panel 110, a polarizer 120, a frame 130 and fixing components 140. The LCD panel 110 is on the frame 130 and is carried by the frame 130. Alignment of liquid crystals within the LCD panel 110 is varied according to driving signal from a driving chip (not shown in FIG. 1) to adjust the brightness of light passing through the LCD panel 110 to output images. The polarizer 120 having four ledges 122 is attached onto the LCD panel 110 and is used for refracting the light passing through the LCD panel 110. A plurality of fixing components 140 go through fixing holes on the ledges 122 to attach the polarizer 120 onto the frame 130 to stick the polarizer 120.

The polarizer 120 with such structure with four ledges 122, however, tends to twist under pull to deteriorate display quality. In hence, it is necessary to solve such problem.

### SUMMARY OF THE INVENTION

The object of the present invention is to provide an LCD device capable of attaching a polarizer to a frame without an establishment of the ledges so that it does not attach the polarizer by fixing components going through fixing holes of ledges. Therefore, it does not happen that the polarizer becomes deformed under pull to deteriorate display quality.

According to the present invention, an LCD device comprises: an LCD panel; a frame, comprising a fixing groove, for carrying on the LCD panel; an optical film on the LCD panel; and a fixing film comprising a plurality of fixing holes and an opening, the optical film engaged with the opening to prevent the optical film from moving, wherein A plurality of fixing components go through the fixing holes and the fixing grooves one by one to attach the fixing film onto the frame.

In one aspect of the present invention, the optical film is a polarizer.

In another aspect of the present invention, the fixing component is a screw.

In still another aspect of the present invention, a contacted position between the fixing film and the optical film is correspondent to non-display area of the LCD panel.

In still another aspect of the present invention, an area of the opening is equal to that of the optical film.

According to the present invention, an LCD device comprises: an LCD panel; a frame, comprising a plurality of fixing grooves, for carrying on the LCD panel; an optical film on the LCD panel; and a plurality of fixing films, each fixing film comprising a fixing hole, the optical film is fixed by the plurality of fixing films to prevent the optical film from moving, wherein a plurality of fixing components go through the fixing holes and the fixing grooves one by one to attach the fixing film onto the frame.

In one aspect of the present invention, the optical film is a polarizer.

In another aspect of the present invention, the fixing component is a screw.

In still another aspect of the present invention, a contacted position between the fixing film and the optical film is correspondent to non-display area of the LCD panel.

In still another aspect of the present invention, each fixing film comprises two fixing members, one of the two fixing members is perpendicular to the other, and two adjacent sides of the optical film are in contact with the two fixing components.

The advantages of the present invention are that the present invention provides an LCD device comprising at least one fixing film for fixing an optical film. The fixing film has at least one fixing hole to attach the fixing film onto a frame. The optical film does not become deformed under pull to deteriorate display quality because the optical film has no need to arrange fixing holes for attaching the optical film onto a frame by screwing.

### BRIEF DESCRIPTION OF THE DRAWINGS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 1 illustrates a structure of a conventional LCD device.

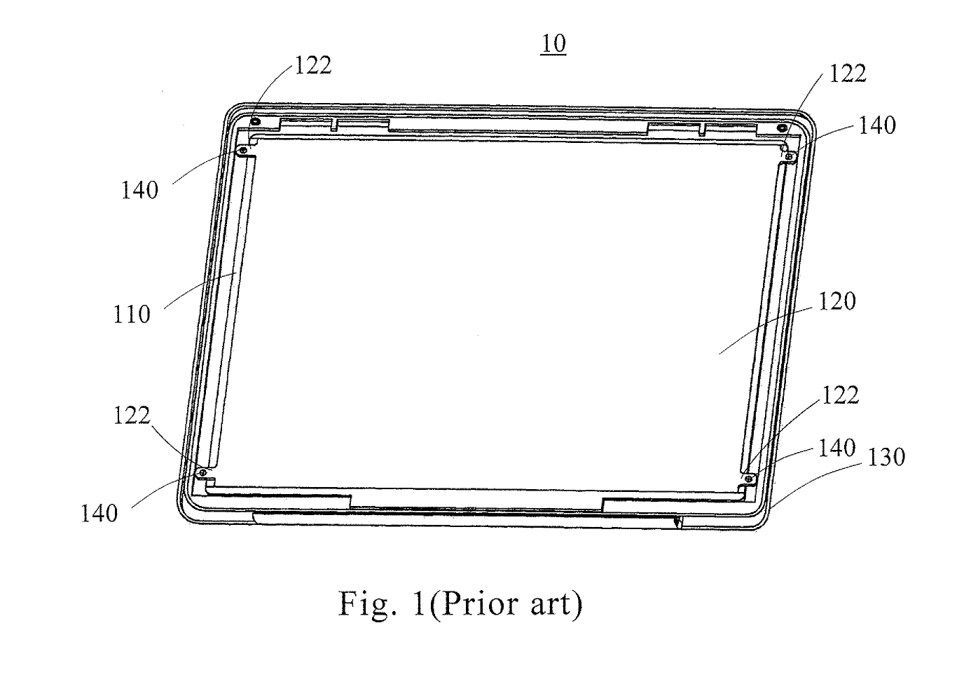

FIG. 2 is a structure diagram of an LCD device according to a first embodiment of the present invention.

FIG. 3 is a partial section view of the assembled LCD device in FIG. 2.

FIG. 4 shows a structure diagram of an LCD device according to a second embodiment of the present invention.

FIG. 5 shows a structure diagram of an LCD device according to a third embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

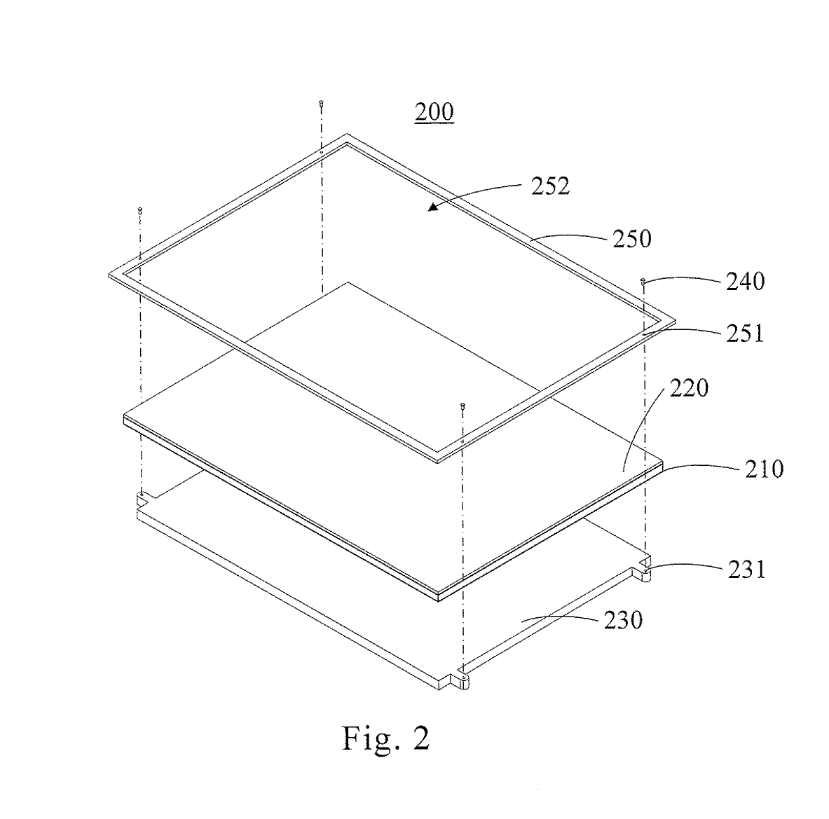

Please refer to FIG. 2. FIG. 2 is a structure diagram of an LCD device 200 according to a first embodiment of the present invention. The LCD device 200 comprises an LCD panel 210, an optical film 220, a frame 230, a fixing film 250 and a fixing component 240. The frame 230 is used for carrying the LCD panel 210 and the optical film 220, and the frame 230 is made of opaque material, such as plastic, metal or in combination. An alignment of the liquid crystals is varied according to driving signal from a driving chip (not shown in FIG. 2) to adjust the brightness of light passing through the LCD panel 210 to output images. The optical film 220 is attached onto the LCD panel 210. The optical film 220 may be a polarizer comprising a Polyvinyl Alcohol (PVA) film, a Triacetate Cellulose (TAC) film, and a biaxial retarder, The optical film 220 also may be a diffuser, a prism film, a Brightness Enhancement Film (BEF), a Dual Brightness Enhancement Film (DBEF), a Diffused Reflective Polarizer (DRPF) or a combination of any of the elements mentioned above. The fixing film 250 sticks to the frame 230 and is used for fixing the optical film 220 to prevent from moving.

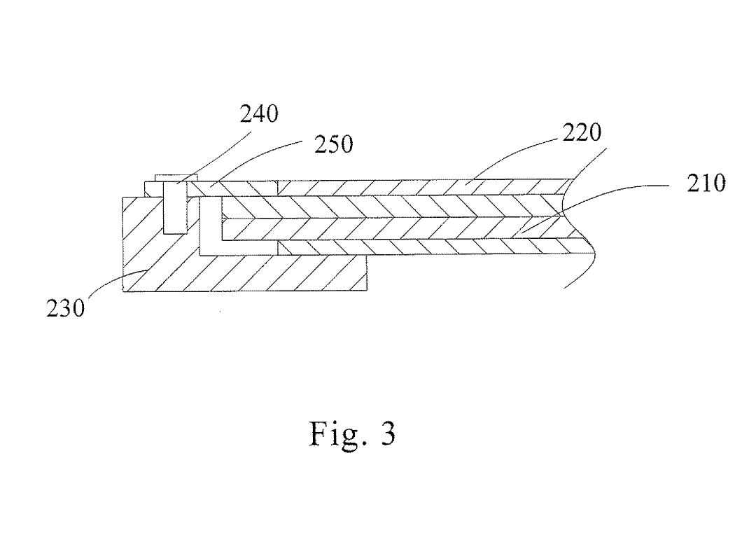

Please refer to FIG. 2 in conjunction to FIG. 3. FIG. 3 is a partial section view of the assembled LCD device 200 in FIG. 2. The fixing film 250 comprises a plurality of fixing holes 251 and an opening 252. Preferably, an area of the opening 252 is equal to that of the optical film 220 so that the optical film 220 is engaged with the fixing film 250 to prevent the optical film 220 from moving. Preferably, the contacted position between the fixing film 250 and the optical film 220 corresponds to non-display area of the LCD panel 210. Therefore, the fixing film 250 does not cover display area of the LCD panel 210 to deteriorate display quality. The plurality of fixing holes 251 are set up on one side of the fixing film 250. A plurality of fixing components 240 go through each fixing hole 251 and a correspondent fixing groove 231 on the frame 230 one by one to attach the optical film 250 to the frame 230. The fixing component 240 is able to be screw or rivet. The fixing film 250 in another embodiment adheres to the frame 230 by a adhesive structure (not shown). For instance, a adhesive structure may be adhesive to stick the optical film 250 to the frame 230.

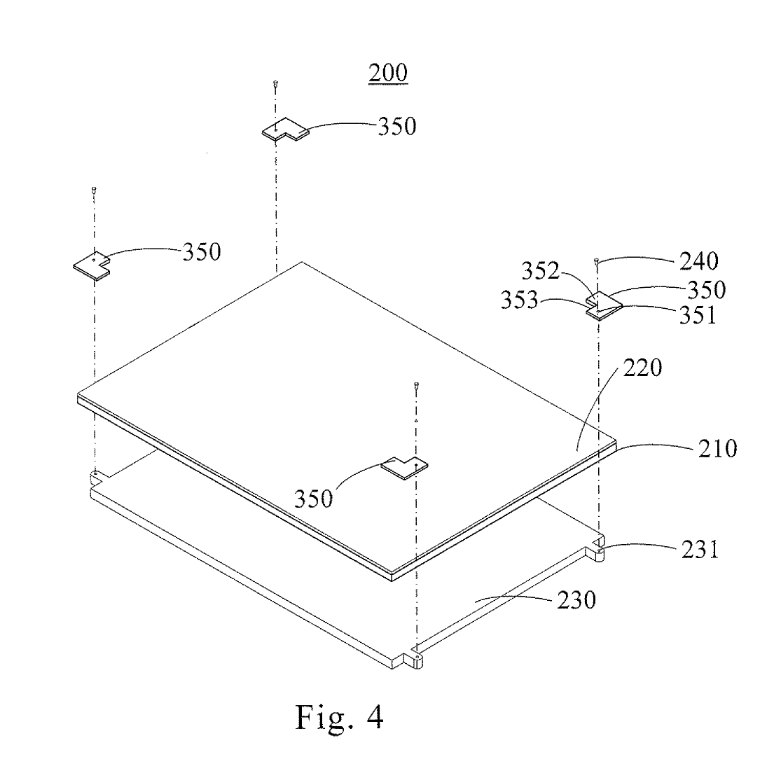

Please referring to FIG. 4, FIG. 4 shows a structure diagram of an LCD device 200 according to a second embodiment of the present invention. The components in FIG. 3 with the same label in FIG. 2 have the same functions and structures, and thus there is no further description for the components. Differing from using a single fixing film 250 in FIG. 2, the LCD device 200 in FIG. 4 comprises four fixing films 350. The four fixing films 350 respectively locate at four corners of the optical film 220. Each fixing film 350 comprises a fixing hole 351, and the optical film 220 is fixed by the four fixing films 350 to prevent from moving. A plurality of fixing components 240 go through each fixing hole 351 and a correspondent fixing groove 231 one by one to attach the fixing film 350 to the frame 230, preventing the optical film 220 from moving. Each fixing film 350 comprises two fixing members 352, 353, and the fixing member 352 is perpendicular to the fixing member 353. The two adjacent sides of the optical film 250 are in contact with the two fixing members 352, 353.

Besides, the number of the fixing film 350 may be two, one locates at one corner of the fixing film 350, and the other locates at the diagonal corner.

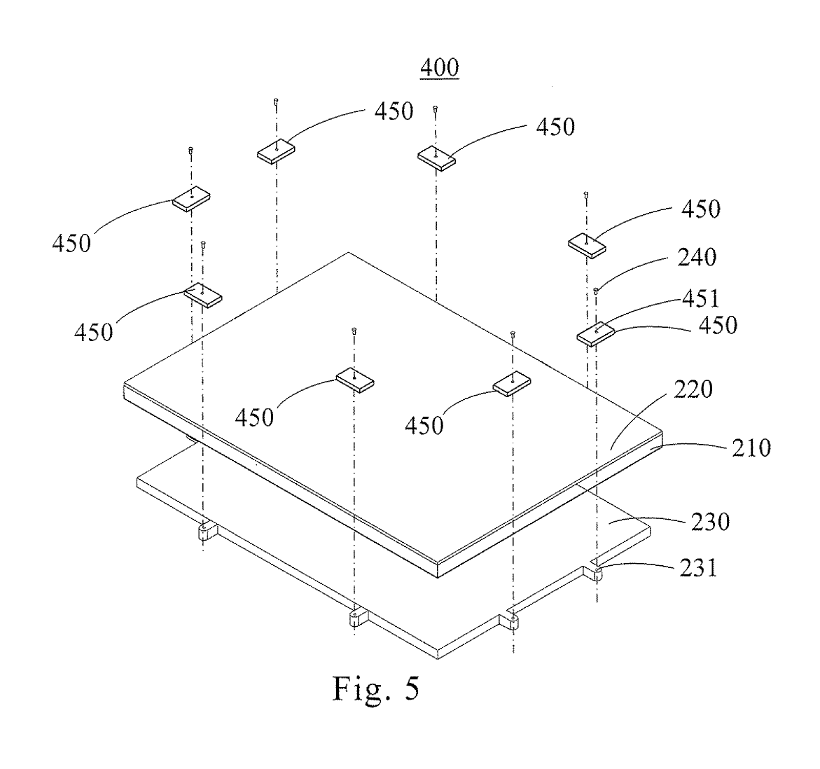

Please refer to FIG. 5. FIG. 5 shows a structure diagram of an LCD device 200 according to a third embodiment of the present invention. The components in FIG. 5 with the same label in FIG. 2 have the same functions and structures, and thus there is no further description for the components. The LCD device 200 of the third embodiment comprises a plurality of fixing films 450 respectively locating at four edges of the optical film 220. A plurality of fixing components 240 go through each fixing hole 451 and a correspondent fixing groove 231 one by one to attach the fixing film 450 to the frame 230, preventing the optical film 220 from moving.

Comparing with the prior art, the present invention provides an LCD device comprising at least one fixing film. The fixing film is used for preventing an optical film from moving and has at least one fixing hole to stick onto a frame. The optical film does not become deformed under pull to deteriorate because the optical film has no need to arrange fixing holes for attaching the optical film onto a frame by screwing.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. An LCD device, comprising:
an LCD panel;
a frame, comprising a fixing groove, for carrying on the LCD panel;
an optical film on the LCD panel; and
a fixing film comprising a plurality of fixing holes and an opening, the optical film engaged with the opening to prevent the optical film from moving, wherein a plurality of fixing components go through the fixing holes and the fixing grooves one by one to attach the fixing film onto the frame.

2. The LCD device of claim 1, wherein the optical film is a polarizer.

3. The LCD device of claim 1, wherein the fixing component is a screw.

4. The LCD device of claim 1, wherein a contacted position between the fixing film and the optical film is correspondent to non-display area of the LCD panel.

5. The LCD device of claim 1, wherein an area of the opening is equal to that of the optical film.

6. An LCD device, comprising:
an LCD panel;
a frame, comprising a plurality of fixing grooves, for carrying on the LCD panel;
an optical film on the LCD panel; and
a plurality of fixing films, each fixing film comprising a fixing hole, the optical film is fixed by the plurality of fixing films to prevent the optical film from moving, wherein a plurality of fixing components go through the fixing holes and the fixing grooves one by one to attach the fixing film onto the frame.

7. The LCD device of claim 6, wherein the optical film is a polarizer.

8. The LCD device of claim 6, wherein the fixing component is a screw.

9. The LCD device of claim 6, wherein a contacted position between the fixing film and the optical film is correspondent to non-display area of the LCD panel.

10. The LCD device of claim 6, wherein each fixing film comprises two fixing members, one of the two fixing members is perpendicular to the other, and two adjacent sides of the optical film are in contact with the two fixing components.
